(19) United States
(12) Patent Application Publication
(10) Pub. No.: US 2008/0005850 A1
(43) Pub. Date: Jan. 10, 2008

(54) PROCESS FOR DE-COLORING RESIDUE FROM PERSONAL WASH OR COSMETIC COMPOSITIONS COMPRISING DYE WITH AZO BOND USING REDUCING AGENTS AS DE-COLORING AGENTS

(75) Inventors: HANG CHEN, CHESHIRE, CT (US); YURY YAROVOY, MONROE, CT (US); HAO OUYANG, HAMDEN, CT (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: CONOPCO, INC., d/b/a UNILEVER, ENGLEWOOD CLIFFS, NJ (US)

(21) Appl. No.: 11/428,900

(22) Filed: Jul. 6, 2006

(51) Int. Cl. C11D 3/00

(52) U.S. Cl. 8/115.51

(57) ABSTRACT

A process for de-coloring liquid or solid residue compositions containing a dye having an azo colorant is disclosed.

### FIELD OF THE INVENTION

The present invention relates to processes for de-coloring residue (e.g., excess or waste composition formed during production of liquid or solid personal wash or cosmetic compositions) which residue comprises dyes having at least one azo bond. For example, de-coloring of dyed soap scrap compositions allows the scrap to be re-used to make more of the composition (e.g. bar) which has no such dye.

### BACKGROUND OF THE INVENTION

Many personal wash or cosmetic compositions (e.g., solid cleansing bar compositions, shampoos conditioners, sun creams) contain colorants so that the final compositions are colored (e.g., pink soap bar). The colorants are typically molecules containing one or more chromophoric groups in their chemical structure and which are therefore capable of coloring diverse substances by selective reflection or by transmission of daylight. The subject invention is concerned particularly with azo colorants, i.e., colorant molecules wherein the chromophoric group or groups is a double-bonded azo linkage.

During the production of personal wash and cosmetic compositions, there is typically some portion of the final composition which is considered “residue”. In the production of solid bar compositions, for example, this “residue” might be bar shavings which are released from a soap mass while the mass is extruded, cut and stamped; or soap scrap from the processing equipment when one line of soap is re-set for with another color. It may also be bars or billets which fall outside product specifications for a given product. In theory, the residue may be any composition (solid or liquid) which is left over in the processing equipment or as excess product when the final product (e.g., bar, shampoo) is removed from the line and packaged. The residue will of course have the same formulation.

Like the final product or composition, the residue will also contain colorant. It is often desirable to use this excess residue or material to make additional product (e.g., to not waste the residue). However, since similar products which may be made during the processing/engineering of the product will generally not have the same colorant, it is critical to be able to remove the colorant (e.g., to de-color the residue, also referred to sometimes as a re-work) in order to allow the material to be used. Ability to remove colorant and re-use the residue in a white or different colored product can result in huge cost savings.

As such it would be a tremendous benefit to find a single and effective way to remove colorant from residue or rework.

In its broadest form, the invention relates to a process of de-coloring liquid or solid residue which results from production of personal wash or cosmetic compositions and which residue compositions contain a dye having one or more azo-bonds. The process comprises treating residue composition containing the dye with a reducing agent which reducing agent in turn chemically reacts with the azo colorant and cleaves the azo bond(s). In cleaving the azo bond(s), the chromophore in the dye is broken down and accordingly the personal wash or cosmetic residue composition is de-colored.

In a preferred embodiment, the process is used to react reducing compounds with solid bar soap residue composition and, in one embodiment, the soap comprises at least some unsaturated fatty acids.

While it is not novel in the art to provide bleaching compositions (see U.S. Pat. No. 6,416,687 to Agostini et al., for example relating to bleach compositions for fabrics), bleaching is done through an oxidation process using H₂O₂, for example, as oxidizing agent and FeCl₂ as catalyst. This is not a de-coloring process using reducing compounds to break azo bonds in dye-containing compositions. In addition, compositions of Agostini are not personal wash or cosmetic compositions. There is also no disclosure of de-coloring solid soap residue.

Another method for removing colorants is through dye absorption using, for example, activated carbons. This process is used for removing textile dyes from waste water. Typically, these are highly diluted aqueous systems wherein dyes are the main components to be removed (e.g., at about 300 ppm).

Use of reducing agent on azo dyes is disclosed in Voyksner et al., “Determination of Aromatic Amines Originating from Azo Dyes By Chemical Reduction Combined with Liquid Chromatography/Mass Spectrometry”, Environ. Sci. Technology, pp 1665-1672 (27), 1993. This reference relates to breaking down dye effluent and does not teach or disclose reduction of azo-containing dyes for de-coloring in any capacity at all, let alone for de-coloring liquid or solid residue associated with personal wash and/or cosmetic compositions.

As far as applicants are aware, there is no process for de-coloring liquid or solid residue (re-work from personal wash or cosmetic compositions) using reducing agents for azo-containing dyes found in the residue compositions so that the residue compositions can be recycled for use in producing products containing no colorant and/or different colorant.

### BRIEF DESCRIPTION OF THE INVENTION

Unexpectedly, applicants have now found a process for de-coloring liquid or solid residue from personal wash or cosmetic compositions containing a dye having one or more azo bonds which process comprises combining the liquid or solid residue containing the dye with a reducing agent(s) that chemically reacts with the dyes to cleave the azo bond(s) in said dyes. The chromophore is thus broken and the residue is de-colored.

More specifically, the invention comprises a process for de-coloring residue formed during production of personal wash or cosmetic compositions comprising azo-containing compounds which process comprises combining said residue with reducing agents under conditions such that the reducing agent reacts with the colorant in the residue and removes the color from the residue.

These and other aspects, features and advantages will become apparent to those of ordinary skill in the art from a reading of the following detailed description and the appended claims. For the avoidance of doubt, any feature of one aspect of the present invention may be utilized in any other aspect of the invention. It is noted that the examples given in the description below are intended to clarify the invention and are not intended to limit the invention to those examples per se. Other than in the experimental examples, or where otherwise indicated, all numbers expressing quantities of ingredients or reaction conditions used herein are to be understood as modified in all instances by the term “about”. Similarly, all percentages are weight/weight percentages of the total composition unless otherwise indicated. Numerical ranges expressed in the format “from x to y” are understood to include x and y. When for a specific feature multiple preferred ranges are described in the format “from x to y”, it is understood that all ranges combining the different endpoints are also contemplated. Where the term “comprising” is used in the specification or claims, it is not intended to exclude any terms, steps or features not specifically recited. All temperatures are in degrees Celsius (° C.) unless specified otherwise. All measurements are in SI units unless specified otherwise. All documents cited are—in relevant part—incorporated herein by reference.

### BRIEF DESCRIPTION OF THE DRAWINGS

FIG. 1 shows wavelength of white bar and of pink bar before treatment of pink bar residue with reducing agent (control).

FIG. 2 shows wavelength of both bars after treatment. As seen, after treatment, reflectance of pink bar at 400-600 nm range is now the same as that of white bar. This shows dye coloring has been removed.

### DETAILED DESCRIPTION OF THE INVENTION

The present invention relates to the discovery that reducing agents can be used to react with azo-containing colorants present in personal wash and cosmetic compositions to reduce the azo linkage (chromophore group) and de-color the compositions. The invention relates to the process of de-coloring liquid, or solid residue from personal wash or cosmetic compositions containing such colorant.

As indicated, in its broadest form, the invention relates to a process of de-coloring liquid or solid residue which results production of personal wash or cosmetic compositions and which compositions contain a dye containing at least one or more azo bonds. The process comprises treating the residue composition with reducing agent which reducing agent, in turn, chemically reacts with azo colorant such that the azo bond(s) (which define the chromophore) are cleaved and the residue composition is de-colored.

In one embodiment, the residue is specifically solid bar residue (e.g., “chips”) and, in a subset of this embodiment, the bar residue compositions comprise some unsaturated fatty acid.

Each of the components is described in more detail below.

Azo Colorant

Azo colorants encompass substances, which have one or more chromophoric groups in their chemical structure and therefore are capable of coloring diverse substances by selective reflection or by transmission of daylight. Azo colorants include both azo dyes and azo pigments.

Azo colorants range in shade from greenish yellow to orange, red, violet and brown. The colors depend largely on the chemical constitution, whereas different shades rather depend on the physical properties.

The part of an azo colorant molecule which produces color, the chromophore group, is a double bonded azo linkage. The chromophoric group of azo colorants alters color of a substrate, either by selective absorption or by scattering of visible light, i.e., light with wavelengths of approximately 400-750 nm.

The azo linkage consists of two nitrogen atoms, which are also linked to carbon atoms. At least one of these carbon atoms belongs to an aromatic carboxyl, an aryl moiety, usually benzene or naphthalene derivatives or a heterocycle, e.g., pyrazolone, thiazole. The second carbon adjoining the azo group may also be part of an aliphatic derivative, e.g., acetoacetic acid.

In general, an azo colorant molecule can be summarized as follows:
aryl-N═N—R,

where R can be an aryl, heteroaryl or —CH═C(OH)— alkyl derivatives.

Examples of specific dyes which are targeted by the invention include the following:

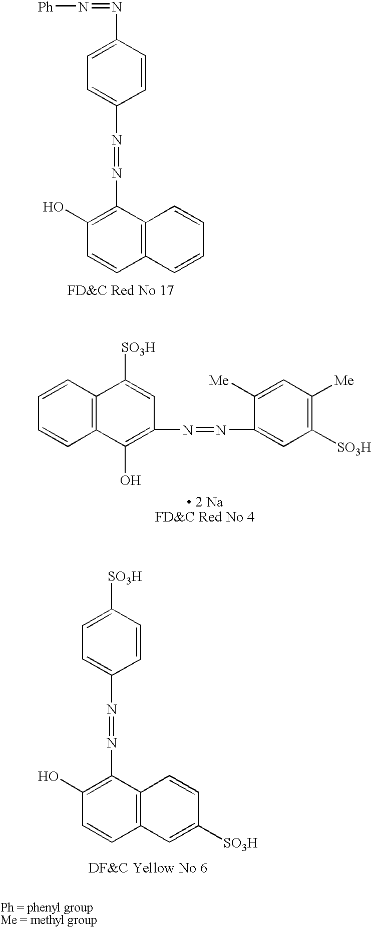

Typical dyes are present in the residue at a level of from about 0.0001 to 3% by wt. preferably 0.001 to 2% by wt. of the composition.

Reducing Agent

In principle, the reducing agent can be any agent capable of reducing azo, azoxy or hydrazo bonds.

The reducing agent may be, for example, a metal salt including, for example, alkali metal salts of Group 4A metals, such as stannous chloride (SCl₂) or salts of the 1A or 2A active metals.

In addition, the reducing agent may be electropositive elemental metals (Li, Na, Sn, Fe, Zn, Al), especially those with relatively small ionization energies and low electro negativities (Na, Mg). They also include metal hydrides, such as NaH, CaH₂; and hydride transfer agents such as NaBH₄ (sodium borohydride) or LiAlH₄ (Lithium aluminum hydride).

Other common reducing agents include nascent hydrogen, potassium ferricyanide (K₃Fe(CN)₆), sodium amalgam, stannous ion, salts of sulfite compounds (e.g., sodium sulfite, NaHSO₃; sodium hyposulfite, Na₂S₂O₃; or sodium hydrosulfite Na₂S₂O₄), hydrazine etc.

The concentration of reducing agent is generally, although not necessarily, at least about 1 mg of reducing agent for each gram of residue, preferably 3 mg per gram residue, even more preferably 5 mg reducing agent per gram of residue composition. It should be understood that the greater the amount of reducing agent used, typically the faster and/or more effective will be the de-coloring reaction.

Process

As indicated, the process of the invention involves treating residue composition left over from solid or liquid personal wash or cosmetic compositions containing a dye comprising azo bond or bonds. Such “treatment” may include combining the product with the reducing agent. If solid, the residue should be heated to melt; and if residue is in liquid form, no heating is generally required. Of course, residue may be semi-solid or something between liquid and solid.

Such “residue” may include, for example, recycle soap materials (e.g., shavings when bar is cut and stamped) generated on a soap making line or, for example, any excess liquid formulation (e.g., shampoo) formed during production of shampoo or personal wash or cosmetic compositions.

The invention involves a process for treating (e.g., combining, with optional mixing or stirring) the residue with reducing agent under such conditions that the azo-containing dye found in the residue is contacted with the reducing agent and the chromophore(s) defining the dye is targeted and broken down during the chemical reaction.

In one embodiment, the residue is solid soap residue (e.g., soap “chips” recovered from a soap plodder). Further, the soap composition may comprise unsaturated fatty acid. The unsaturated fatty acids are substantially unaffected by reduction chemistry, the way they might be if an oxidation chemistry were used.

A broad example of the reaction mechanism is disclosed below.

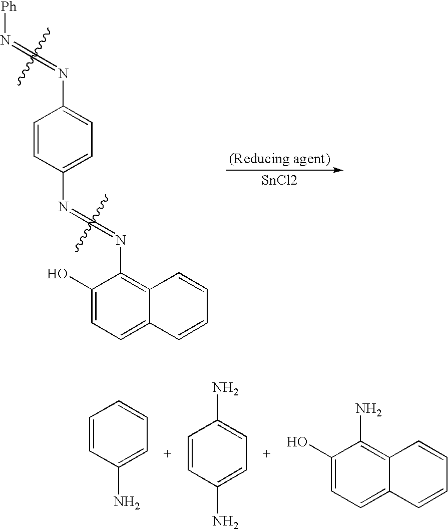

In the above reaction, SnCl₂ is an illustrative example of reducing agent which may be used although, of course, other reducing agents as noted above may also be used.

The examples below are intended to illustrate the invention and are not intended to limit the scope of the claims in any way.

### EXAMPLES

### Example 1

### Reduction of Azo Dye by Reducing Agent Showing Conversion of Color to Clear Solution

To show the conversion of dye to clear solution in the presence of reducing agent, applicants conducted the following experiment.

In a reaction flask was added 1 mg pink colorant (FDC Red No. 17) in 1 ml hexane. The solution was diluted to 100 times with hexane and 30 mg SnCl₂ (reducing agent) was added. The mixture was stirred overnight. After overnight, the pink color solution converted to clear solution.

### Examples 2-5 and Comparative A & B

To show process of de-coloring residue, applicants conducted the following experiments.

### Example 2

In a reaction flask were added 2 grams of pink bar composition comprising 40-60% synthetic surfactant; 25% free fatty acid; and 30 mg SnCl₂. The mixture was heated to 130° C. and melted After stirring for 10-15 minutes, the pink composition turned to white based on the measure. Heating was stopped and composition was cooled to room temperature.

### Example 3

In a reaction flask were added 2 grams of above pink composition and 15 mg SnCl₂. The mixture was heated to 130-140° C. And melted. After stirring for 10 minutes, the pink composition turned to white. Heating was stopped and composition was cooled to room temperature.

### Example 4

In a reaction flask were added 2 grams of above pink composition and 5.9 mg SnCl₂. The mixture was slowly heated to 125-135° C. and melted with a mechanical stirrer. After stirring for 10 minutes, the pink composition turned to light pink. Heating was stopped and composition was cooled to room temperature.

### Example 5

In a reaction flask were added 1 gram of above pink composition and 1 mg SnCl₂. Mixture was slowly heated to 150° C. and melted with mechanical stirrer. After stirring for 15-20 minutes, the pink composition turned light pink. Heating was stopped and composition was cooled to room temperature.

### Comparative A

In a reaction flask were added 2 grams of above pink composition and 1.9 mg SnCl₂. The mixture was slowly heated to 125-130° C. and melted with a mechanical stirrer. After stirring for 10 (minutes), the composition showed substantially no color change (stayed at original pink color). This example, together with Example 5, shows that there must be at least enough reducing agent for each gram residue to achieve the reduction. For the case of SnCl₂, this amount is somewhere close to ratio of 1 mg. reducing agent to 1 gram bar composition. It should be understood however, that, for different reducing agents, this amount may vary although, generally, the more reducing agent used relative to amount of soap composition, the better and/or quicker the de-coloring results. After melting, heating was stopped and composition was cooled to room temperature.

### Comparative B

In a reaction flask were added 2 grams of green composition (no azo bond in green dye) and about 60 mg SnCl₂. The mixture was slowly heated to about 130° C. and melted with mechanical stirrer. After stirring for an hour, the green color was the same. Heating was stopped and composition cooled to room temperature. This example shows that the reducing process of the invention applies to dyes having azo bonds, but not to dyes (such as the green one) which don't.

A summary of Examples 2-5 and Comparatives A & B is set forth in Table I below:

TABLE 1

| | | | Grams of | | | | | | Time for |
|---|---|---|---|---|---|---|---|---|---|
| | Starting | Ending | bar | | Grams of | | Melting | | Color |
| Example | Color | Color | composition | | SnCl₂ | | Temp | | Change |
| 2 | Pink | White/Cream | ˜2 | grams | ˜30 | mg | 130° | C. | 10-15 |
| | | | | | | | | | minutes |
| 3 | Pink | White/Cream | ˜2 | grams | ˜15 | mg | 130-140° | C. | 10-15 |
| | | | | | | | | | minutes |
| 4 | Pink | Light Pink | 2.0042 | grams | 5.9 | mg | 125-135° | C. | 30 |
| | | | | | | | | | minutes |
| 5 | Pink | Light Pink | 1 | gram | 1 | mg | 150° | C. | 15-20 |
| | | | | | | | | | minutes |
| Comparative | Pink | Pink | 2.0174 | grams | 1.9 | mg | 125-130° | C. | 22 |
| A | | | | | | | | | minutes |
| Comparative | Green | Starting | ˜2 | grams | ˜60 | mg | 130° | C. | 1 |
| B | | Green | | | | | | | hour |

The bar composition (residue) used in each case comprises:
(1) 40-60% by wt. synthetic anionic surfactant;
(2) 20-30% by wt. free fatty acid;
(3) 1-8% by wt. Alkali metal isethionate;
(4) 4-12% water.

As seen, when sufficient concentration of reducing agent is used in a composition containing dye with azo bond (Examples 2-5), the residue is de-colored. When not enough reducing agent is used (see comparative A versus Example 5, for example), or when no azo bond is in the dye (see Comparative 6), the de-coloring reaction is compromised.

### Example 6

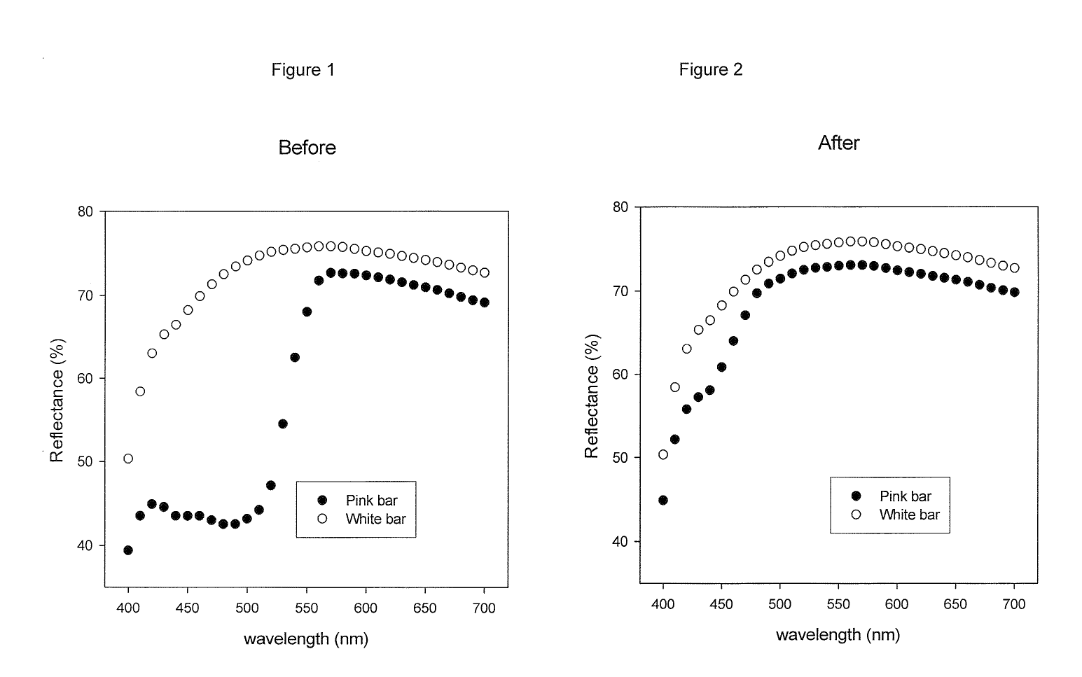

As seen from FIGS. 1 and 2, reflected light at different wavelength (400-700 nm) from sample was compared to reflectance from a white standard and was represented as percentage of total reflectance for each wavelength. The pink bar has low (˜40%) reflectance in 400-500 nm region (blue) compared to white bar (˜60%). The bleached pink bar had a much higher blue reflectance, similar to white. For quantification the whitening parameter L* increased from 83 to 88 compared to 89 of the white bar.

### Examples 7-13

The following additional examples were conducted with different reducing agents.

### Example 7

In a reaction flask were added 1 gm of pink bar composition (same composition of Example 2) and 60 mg sodium hyposulfite Na₂S₂O₃. The mixture was heated to 180° C. and melted. After stirring for 15-20 minutes, the pink composition turned white and yellow. Heating was stopped and composition was cooled to room temperature.

### Example 8

In a reaction flask were added 1 gm of above pink bar composition and 26 mg Na₂S₂O₃. The mixture was heated to 180° C. and melted. After stirring for 15-20 minutes, the pink composition turned white and yellow. Heating was stopped and composition was cooled to room temperature.

### Example 9

Same as Examples 7 and 8, except only 5 mg Na₂S₂O₃ used as reducing agent. Here pink composition turned light pink and yellow, indicating the greater amounts of reducing agent used in Example 7 and 8 yield slightly superior results.

### Example 10

In a reaction flask were added 1 gm of above pink bar composition and 60 mg sodium sulfite (NaHSO₃). The mixture was heated to 180° C. and melted. After stirring for 15-20 minutes, pink composition turned white and light yellow.

### Example 11

Same as Example 10, except only 30 mg NaHSO₃ used. Here, pink composition turned white and light yellow.

### Example 12

Same as Example 10 and 11, except only 5 mg NaHSO₃ used. Here the pink composition turned light pink, again indicating the amount of reducing agent can affect result and/or timing.

### Example 13

In a reaction flask were added 1 gm of above pink bar composition and 100 mg zinc. The mixture was heated to 150° C. and melted. After stirring for 15-20 minutes, pink composition turned light yellow.

A summary Example 7-13 is set forth in Table 2 below.

TABLE 2

| | | | | Amount | | |
|---|---|---|---|---|---|---|
| | | | Grams of | and name | | Time for |
| | Starting | Ending | bar | of reducing | Melting | Color |
| Example | Color | Color | composition | agent | Temp | Change |
| 7 | Pink | White & | 1 g | 60 mg | 180° C. | 15-20 |
| | | yellow | | Na₂S₂O₃ | | minutes |
| 8 | Pink | White& yellow | 1 g | 26 mg | 180° C. | 15-20 |
| | | | | Na₂S₂O₃ | | minutes |
| 9 | Pink | Light | 1 g | 5 mg | 180° C. | 15-20 |
| | | pink/yellow | | Na₂S₂O₃ | | minutes |
| 10 | Pink | White & light | 1 g | 60 mg | 180° C. | 15-20 |
| | | yellow | | NaHSO₃ | | minutes |
| 11 | Pink | White & light | 1 g | 30 mg | 180° C. | 15-20 |
| | | yellow | | NaHSO₃ | | minutes |
| 12 | Pink | Light pink | 1 g | 5 mg | 180° C. | 15-20 |
| | | | | NaHSO₃ | | minutes |
| 13 | Pink | Light yellow | 1 g | 100 mg | 150° C. | 15-20 |
| | | | | Zn | | minutes |

As noted, a variety of reducing agents may be used. The intensity and/or timing of de-coloring can be affected by how much reducing agent is used relative to bar composition.

1. A chemical process for de-coloring solid residue compositions selected from the group consisting of bar shavings, soap scrap, bars or billets falling outside product specification and mixtures thereof which are left over from production of personal wash bar compositions, wherein said residue compositions comprise an azo colorant having one or more azo bonds, wherein said process comprises:
(1) collecting said solid residue compositions left over from production of the bar;
(2) heating said solid residue to melt; and
(3) combining said solid residue composition with at least about 0.5 wt. % reducing agent(s) to achieve reduction and under conditions that the reducing agent chemically reacts with said azo colorant and removes said colorant from the residue.

2. A process according to claim 1, wherein said chemical reaction of reducing agent and azo colorant comprises the reducing agent cleaving azo bond or bonds to de-color residue containing said azo colorant.

3. A process according to claim 1, wherein said azo colorant comprise
aryl-N═N—R
where R is aryl, heteroaryl or —CH═C(OH)— alkyl derivatives.

4. A process according to claim 1, wherein reducing agent is selected from the group consisting of alkali metal salts of Group 4A; salts of 1A or 2A active metals; electropositive elemental metals; metal hydrides; hydride transfer agents; and mixtures thereof.

5. A process according to claim 4, wherein the alkali metal salt of Group 4A is SnCl₂.

6. A process according to claim 4, wherein the electropositive elemental metal is selected from Li, Na, Sn, Fe, Zn, Al and mixtures thereof.

7. A process according to claim 4, wherein the metal hydride is NaH or CaH₂.

8. A process according to claim 4, wherein the hydride transfer agent is NaBH₄ or LiAlH₄.

9. A process according to claim 1, wherein the reduction agent is a sulfite compound.

10. A process according to claim 9, wherein said sulfite is selected from the group consisting of alkali metal sulfite, alkali metal hyposulfite and alkali metal hydrosulfite.
